(19) United States
(12) Patent Application Publication
(10) Pub. No.: US 2011/0119112 A1
(43) Pub. Date: May 19, 2011

(54) Modeling Tool for Reducing Resource Usage or Emissions

(75) Inventors: Udo Waibel, Los Altos, CA (US); Bryan Shih, Milpitas, CA (US)

(73) Assignee: HARA SOFTWARE, INC., Redwood City, CA (US)

(21) Appl. No.: 12/748,290

(22) Filed: Mar. 26, 2010

(51) Int. Cl. G06Q 10/00; G06F 17/30; G06F 17/00; G06Q 50/00

(52) U.S. Cl. 705/7.36; 707/748; 715/212; 705/317; 707/E17.084

(57) ABSTRACT

A centralized modeling system is implemented via a host server that is accessible to a large number of clients (organizations) using a website. In one example, it is assumed a client wishes to reduce its CO2e emissions by reducing its energy consumption by a certain amount per year. The client then enters a budget, and the server or client identifies a list of all the possible initiatives (specific projects) for electricity reduction. The client enters certain relevant information to customize the initiatives. The server may then automatically calculate, using conversion factors, each initiative's cost and estimated electricity and emissions reduction per year, among other metrics. The software allows the client to repeatedly select any combination of the initiatives and then models the resulting total energy savings and CO2e emission reduction, and any budgeted amount remaining. Based on the modeling, the client then decides on the overall strategy using a combination of the initiatives.

### FIELD OF THE INVENTION

The present invention generally relates to the field of emissions or resource management, such as greenhouse gas (GHG) emissions management or energy usage management. More specifically, the invention describes a modeling method, performed by a processing system, that combines various reduction initiatives, out of a larger group of initiatives, to achieve the client's reduction goal within a certain budget and time frame.

### BACKGROUND

“Emissions” refer to the introduction of chemicals, particulate matter, or biological materials into the atmosphere, ground, or water system that potentially can cause harm or discomfort to humans or other living organisms, or may damage the natural environment.

GHG is a collective term for gases such as carbon dioxide, methane, HFCs, SF6, and nitrous oxide that trap heat in the atmosphere and contribute to climate change. GHG accounting and reporting is the discipline of tracking GHGs produced as a result of executing business processes, including manufacturing, travel, keeping of livestock, etc.

The term “carbon dioxide equivalent” (CO2e) is a common normalized unit of measurement, such as expressed in tonnes of CO2e, that is used to compare the relative climate impact of the different GHGs. The CO2e quantity of any GHG is the amount of carbon dioxide that would produce the equivalent global warming potential. There are publicly accepted factors that are used to convert an entity's emissions, usage of resources (e.g., electricity, gas, oil, coal, etc.), or waste products, among other things, into a CO2e emission.

A company or other entity may want to, or be required to, reduce their CO2e emissions or energy usage. For example, a company's CO2e emissions may be capped by a governmental or industrial organization within an established time frame. A company may wish to reduce energy consumption simply to save money.

It is a complex task to evaluate the effects of one or more initiatives to lower a company's emissions or energy usage to meet their target or cap, especially when the company has a certain not-to-exceed budget and the initiatives may have different implementation dates. An initiative may be a single activity or project having a definable cost and energy/emission reduction per year.

What is needed is a technique to aid a decision maker in deciding which reduction initiatives to implement to meet the company's target for emissions, energy usage, or other goal within given constraints, such as a budget, and to meet the company's other objectives.

### SUMMARY

In one embodiment, a modeling system is implemented via a host server that is accessible to a large number of clients (organizations) using a website. In the example given herein, it is assumed a client wishes to reduce its CO2e emissions by reducing energy consumption, where the reduction in energy consumption is converted into a reduction in CO2e emissions by applying a conversion factor.

The host server generates a menu-driven website providing the client many options. Only the modeling option relating to the present invention is described herein. Once the client has selected the modeling option of the software program, the client is requested by the website to input certain information needed for the modeling.

The client selects a name for the overall reduction strategy, such as “Facility Measures.” This refers to physical modifications to the client's facility to achieve the reductions. The name may be selected from a group of names provided by the server. The client then provides a short description of the strategy or goal, such as “Energy Reduction Project to Reduce Electricity Consumption By 3300 MW-Hours Per Year.” The client then enters a budget, such as $1,000,000.

Based on the general category of the reduction strategy, the server may present a list of possible initiatives that the client can implement, where any of the initiatives can be combined to achieve the client's goal. Each stored initiative is associated with many algorithms for calculating, for example, the cost of the initiative, the cost savings due to energy reduction, the payback period, the energy reduction per year, and the CO2e emission per year. The client then customizes any initiatives of interest by identifying the facility's area, requirements, facility type, budget/cost for the initiative, time frame for implementing the initiative, personnel responsible for the initiative, energy or fuel usage reduced or increased by the initiative, and any other factors affecting the initiative. The client may also create its own initiatives and enter all required information about the initiative. Other initiatives that may be available to the client may be initiatives created by other users in the organization and stored in the server. There may be dozens of initiatives that are possible to implement to reduce energy consumption.

The client now needs to decide which combination (subset) of initiatives to implement to achieve the target electricity or emissions reduction using the specified budget.

The modeling software allows the client to rank each initiative with respect to various objectives (e.g., save money, improve company image, etc.) identified by the user or server. The objectives may be individually weighted. The server than calculates the overall rankings of the initiatives based on the total weight of each initiative.

The server then displays, such as in a spreadsheet, all the initiatives of interest in their ranked order along with all the information the client needs for selecting an initiative, such as the cost of the initiative, the cost savings due to energy reduction, the payback period, the energy reduction per year, and the CO2e emission per year.

The client then selects any combination of the initiatives, and the software then identifies to the client (in a graphics representation) the effects of the combination in achieving the client's goal and the total cost of the combination. For example, the server may display to the client the total energy savings per year and total CO2e emission reduction per year using the combination and any budgeted amount remaining. The client can repeatedly change the combination in an attempt to achieve the maximum reduction for the budget. The software can also identify any other information about the effects of the combination, and the client can customize the modeling to display all information of interest to the client.

The software may also determine the optimal combination of initiatives to achieve the target reduction at the lowest cost or the largest reduction for the budgeted amount.

This modeling technique can be applied to many other types of resource usage. For example, the modeling can be applied to initiatives that directly reduce emissions, rather than reduce resource usage.

### BRIEF DESCRIPTION OF THE DRAWINGS

FIG. 1 schematically illustrates the centralized modeling system in accordance with one embodiment of the invention.

FIG. 2 is a flowchart of one example of a method performed by the server of the centralized modeling system.

FIG. 3 illustrates a portion of the website display presented to the client while the client is using the system to help create a reduction strategy.

FIG. 4 illustrates how the client and server rank the initiatives based on how each initiative achieves various objectives.

FIGS. 5A and 5B illustrate portions of an on-line spreadsheet filled out by the server, where the client combines different initiatives from the spreadsheet, and the server updates the display of FIG. 3 depending on the combination of initiatives selected.

### DETAILED DESCRIPTION

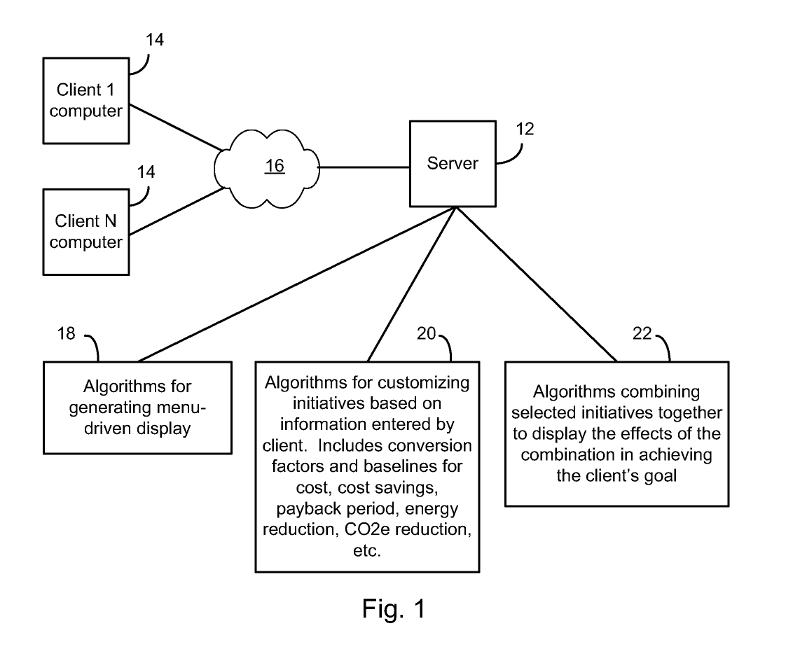

FIG. 1 illustrates the web-based centralized modeling system. A server 12, which may be managed by the host, provides a website that interfaces with the various clients (organizations) to allow the clients to upload data to the server 12, view information generated by the server 12 relating to the modeling, and allow the client to interact with the displayed information to develop usage/emission reduction strategies. The server 12 and the clients' computers 14 communicate via a computer network, such as the Internet 16. A client accesses its account using passwords or other methods.

Although the server 12 has many functions, and there may be a plurality of servers, only one server and its software routines related to the present invention are illustrated. The programs illustrated are algorithms 18, 20, and 22. The algorithms 18 are for generating the menu-driven display and related functions. The algorithms 20 are for customizing the various initiatives based on the information entered by the client. In the example of a client desiring to model an energy reduction strategy to reduce costs and CO2e emissions, the algorithms 20 include algorithms for deriving the customized initiatives' costs, cost savings, payback period, anticipated energy reductions, and CO2e emission reductions. The algorithms 22 include algorithms that combine the selected initiatives together to display to the client the effects of the combination in achieving the client's goal, including meeting the budget. The client can select the particular modeling information to be displayed on the website.

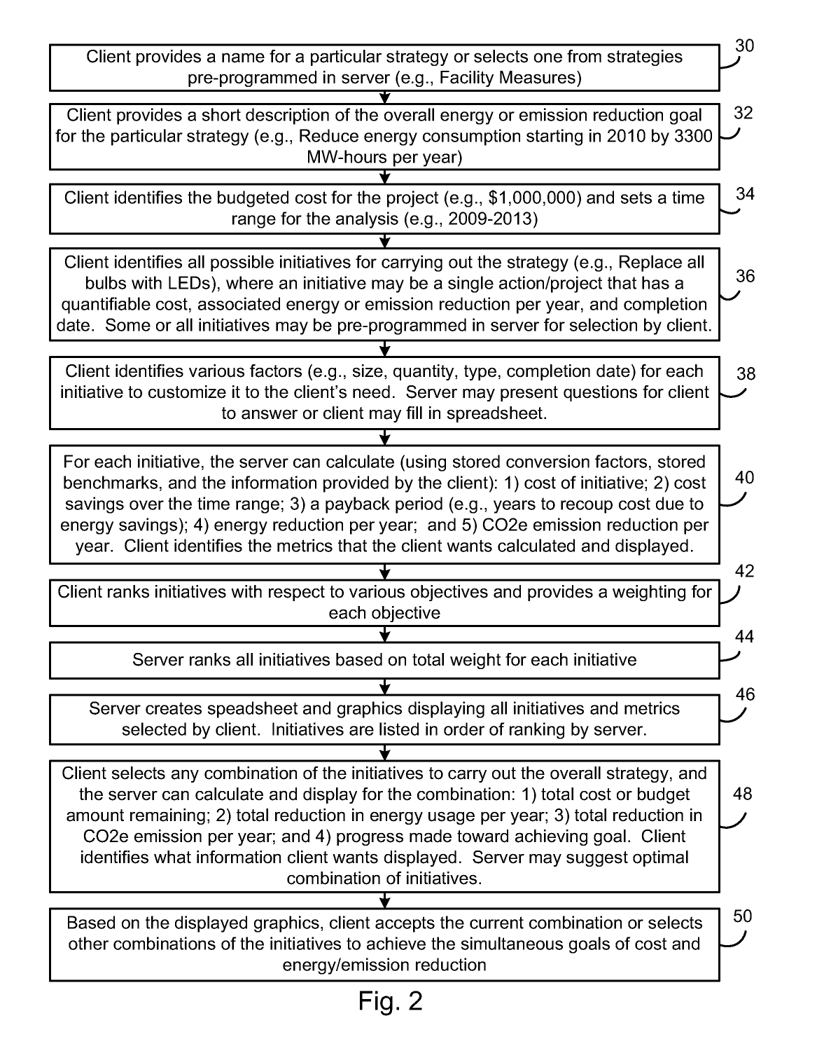

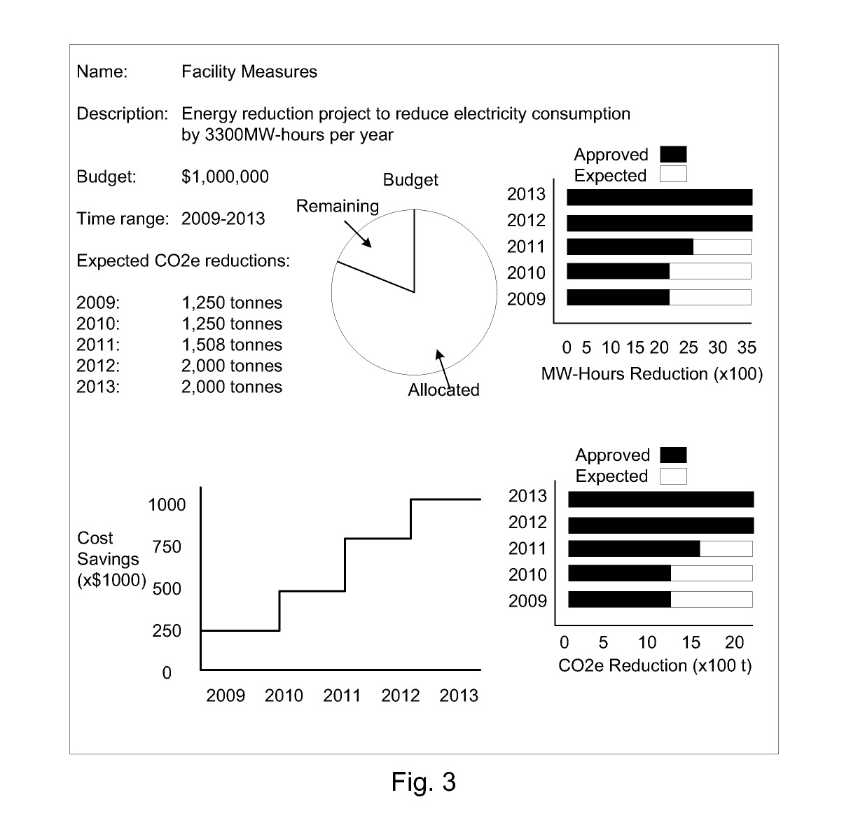

FIG. 2 is a flowchart that will be used to explain the modeling example of FIGS. 3, 4, 5A, and 5B.

FIGS. 3 is a simplified screen shot of the client's computer display screen (part of the client computer 14) after the client has used the server 12 for generating a model of a particular combination of initiatives. Initially, the client proceeds through a menu-driven application to get to the modeling program. The client is then requested to fill in certain information on the screen using a keyboard. In step 30 of FIG. 2, in the particular example, the client provides the name for a particular strategy for reducing the use of electricity. In FIG. 3, the client has entered the name “Facility Measures.” This connotes changes to the client's facility to achieve a reduction in energy usage or emissions. The available names may also be preprogrammed in the server, and the client selects an appropriate one of the names. Selecting one of the preprogrammed names may also automatically identify a group of possible initiatives stored in the server 12 that can be implemented to achieve the reduction goal.

In step 32, the client enters a short description of the reduction goal (in this case, an energy reduction). In FIG. 3, the client has entered the description, “Energy reduction project to reduce electricity consumption by 3300 MW-hours per year.”

In step 34, the client enters the budgeted cost for the project, such as $1,000,000, and enters a time range for the analysis, such as 2009-2013.

In step 36, the client identifies all possible initiatives for carrying out the overall strategy of reducing electricity by modifying the facility. An initiative may be a single action or project that has a quantifiable cost, an associated energy or emission reduction per year, and a completion date. The customer can select any number of the possible initiatives offered by the server 12 that seem reasonable to the client, or the client can create its own set of initiatives.

In step 38, the client customizes each of the initiatives of interest by entering information about the initiative, such the facility size, number of employees, facility type, requirements, budget/cost for the initiative, time frame for implementing the initiative, personnel responsible for the initiative, energy or fuel usage reduced or increased by the initiative, and any other factors affecting the initiative. The client may also create its own initiatives and enter all required information about the initiative. Other initiatives that may be available to the client may be initiatives created by other users in the organization and stored in the server.

In step 40, the server 12 then uses its pre-programmed conversion factors, pre-programmed baselines, and the client customizing information to calculate, for example, the cost of each initiative, the cost savings over the time range, a payback period, energy reduction per year, and CO2e reduction per year. The client may identify to the server what metrics to display for the modeling. The client may instead provide all of the information about an initiative rather than have the server 12 calculate the information. The client may also override any default results calculated by the server 12.

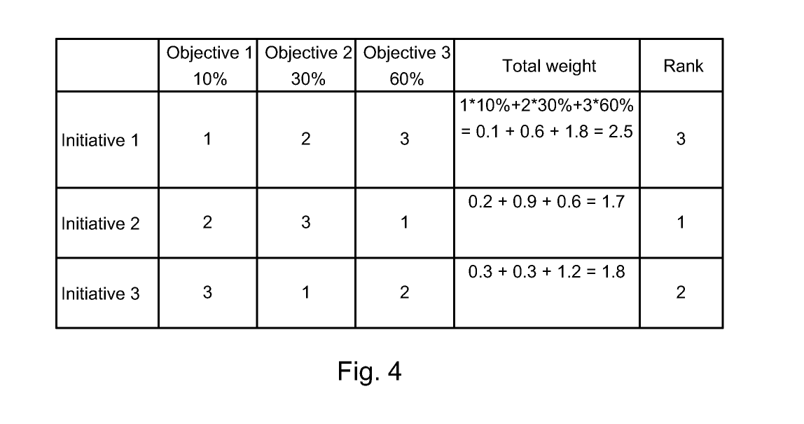

In step 42, the client ranks all the initiatives of possible interest with respect to various objectives the client has identified. FIG. 4 illustrates, in table form, the ranking of the initiatives with the simplified example of three initiatives and three objectives. Objective 1 may be, for example, the effect of the initiative in helping the client's brand awareness. Objective 2 may be, for example, the effect of the initiative in saving costs. Objective 3 may be, for example, the effect of the initiative in increasing revenues. The client assigns each objective a weighting, such as 10%, 30%, and 60%, respectively.

The client then ranks the initiatives for each of the objectives (step 42). The ranking can be ordering the initiatives from best to worst or assigning a scale of, for example, 1-10 to each initiative for each objective.

In step 44, the server 12 then applies the weightings to the client's rankings of the initiatives and creates a ranking of the initiatives based on the total weight of each initiative. The calculations performed by the server 12 are shown in the table of FIG. 4. In the example, the ranking of the three initiatives is initiative 2, initiative 3, and initiative 1.

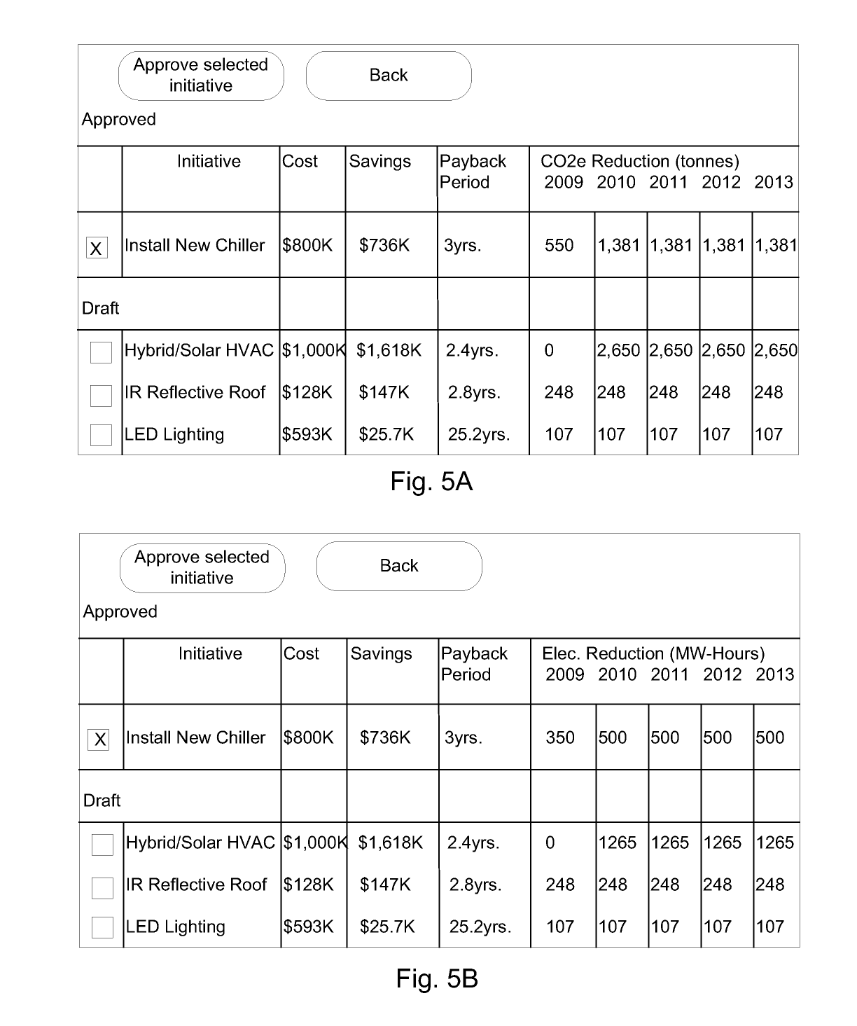

In step 46, the server 12 creates a spreadsheet, such as shown in FIGS. 5A or 5B or a combination of both, that contains all the initiatives, listed in the order of their calculated ranking from best to worst, and calculated metrics customized for the client. FIGS. 5A and 5B show a simplified list of initiatives, and there may be dozens of initiatives listed. FIG. 5A shows that the spreadsheet generated by the server 12 includes columns for CO2e emission reductions for each of the years 2009-2013. FIG. 5B shows that the spreadsheet generated by the server 12 includes columns for electricity reductions for each of the years 2009-2013. A single spreadsheet may contain all the information in FIGS. 5A and 5B and more, as requested by the client. If the initiative will not be implemented until a certain year, the electricity or emission reduction for any year prior to implementation will be 0.

Cost savings may be automatically calculated by multiplying the energy savings by the cost per kwh. Various conversion factors for calculating energy or emissions reductions may be based on publicly available conversion factors, or the conversion factors may be originally developed by the server 12 using information from the client or all clients. The client can optionally fill in these values.

Initially, all the initiatives are listed under the heading “Draft” in FIGS. 5A and 5B, since they have not yet been “Approved” by the client. The approval status is one of the attributes of an initiative that defines if the initiative has been approved for inclusion and execution for the particular strategy.

In step 48, the client then clicks on (using a mouse) a box next to any number of initiatives in the “Draft” section to select that combination (a subset) of initiatives. In response to the selection, the server 12 revises the charts shown in FIG. 3 to show the effects of the combination of the selected initiatives. In the example of FIG. 3, the server 12 calculates and displays the total cost or the budget amount remaining, the energy cost savings, the total reduction in energy usage per year, the total CO2e emission reduction per year, and the progress made toward achieving the goal. The client identifies what information the client wants displayed. The server 12 may suggest an optimal combination of initiatives to achieve the goal or a combination of initiatives that achieves the greatest reduction for the budget. The server 12 takes the rankings of the initiatives into account when identifying an optimal combination.

If the client, based on the modeling in FIG. 3, approves of the combination of initiatives, the client clicks on the “Approve selected initiative” icon in FIGS. 5A or 5B to move the selected initiatives into an upper section of the spreadsheet labeled “Approved.” If the “Approved” initiatives do not achieve the goal, the client can select additional initiatives in the “Draft” section to revise the modeling information in FIG. 3.

Any type of graphic may be used for the modeling, and FIG. 3 shows examples of a pie chart, a numerical listing, a bar chart, and a line chart. In the example of FIG. 3, the two bar charts show the effects of the initiatives in the “Approved” section and the effects of all the checked initiatives, labeled “Expected” in the bar charts. Although the charts of FIG. 3 are intended to reflect the effects of the checked initiatives in the spreadsheet of FIG. 5A or 5B, the spreadsheets are simplified and do not show all the initiatives used to create the charts in FIG. 3.

The cost savings chart may additionally take into account the amortized cost of the initiative.

The client then has all the information it needs to evaluate whether the “Approved” combination of initiatives meets all the goals of the strategy for the budgeted amount. If the result is not adequate, the client may uncheck any initiatives in the “Approved” section and clicks the icon “Back” to move the unchecked initiatives back into the “Draft” section.

In step 50, the client can accept the current “Approved” combination or select a different combination of initiatives. If a different combination is selected, the server 12 recalculates all the information shown in FIG. 3. This iterative process continues until the client is satisfied with the “Approved” combination. The client then uses the information to implement the “Approved” initiatives.

All information is saved by the server 12, and the information can be formatted to provide other useful tools for implementing the initiatives, such as detailed progress goals, cost schedules, responsible personnel, accounting, etc. The time divisions in the various charts may be accounting periods and not necessarily calendar years.

This same type of scenario modeling can be used where the goal is a specified emission reduction (including gaseous or solid emissions) or other goal. The client may be offered, via the website, various units of measurements to select from, and the server 12 algorithms apply the associated conversion factors for generating the modeling feedback for the client.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A method for evaluating scenarios for achieving a reduction goal for a specified budget comprising:
a. receiving, by a programmed processing system, a transmission from an entity identifying a budget for achieving a reduction goal;
b. receiving, by the programmed processing system, a transmission from the entity used to identify a plurality of possible initiatives, customized for the entity, which, in certain combinations, may achieve the reduction goal within the budget, an initiative being an action or project that has a quantifiable cost and a quantifiable associated reduction per time period;
c. receiving, by the programmed processing system, a transmission from the entity identifying a subset of the possible initiatives for achieving the reduction goal;
d. processing, by the programmed processing system, information associated with the subset to determine at least a total cost of the subset and a total reduction if the subset was implemented;
e. transmitting, by the programmed processing system for review by the entity, the total cost of the subset and a total reduction if the subset was implemented;
f. receiving, by the programmed processing system, a transmission from the entity identifying whether the subset of the possible initiatives for achieving the reduction goal is approved by the entity;
g. if the entity has not approved the subset of the possible initiatives, then receiving, by the programmed processing system, one or more transmissions from the entity identifying other subsets of the possible initiatives for achieving the reduction goal; and
h. repeating steps d-g for the other subsets until the entity has approved a subset of the possible initiatives.

2. The method of claim 1 further comprising:
processing, by the programmed processing system, the plurality of possible initiatives to rank the initiatives with respect to achieving the entity's objectives; and
prior to step c, transmitting for review by the entity a listing of the plurality of possible initiatives in a ranked order.

3. The method of claim 2 wherein the programmed processing system ranks the initiatives based on how well each of the initiatives meets a variety of objectives of the entity, wherein at least some of the objectives have a weighting indicating an importance of the objective to the entity.

4. The method of claim 1 further comprising, prior to step c, the programmed processing system generating a spreadsheet for review by the entity, the spreadsheet identifying the plurality of possible initiatives in a ranked order based on how well each initiative met objectives of the entity.

5. The method of claim 4 wherein step c comprises the programmed processing system receiving the transmission from the entity selecting a subset of the possible initiatives from the spreadsheet.

6. The method of claim 1 wherein the programmed processing system identifies an optimal combination of the initiatives based on various factors.

7. The method of claim 6 wherein the various factors include cost.

8. The method of claim 6 wherein the various factors include a quantity of reduction achieved by each initiative.

9. The method of claim 6 wherein the various factors include a ranking of the initiatives based on how well each of the initiatives meets a variety of objectives of the entity.

10. The method of claim 1 wherein the reduction goal is a reduction of equivalent CO2 emissions.

11. The method of claim 1 wherein the reduction goal is a reduction of energy usage.

12. The method of claim 1 wherein the reduction goal is a reduction of resource usage.

13. The method of claim 1 wherein step e comprises generating a graphics display for the entity illustrating the total cost of the subset and a total reduction if the subset was implemented.

14. The method of claim 1 further comprising, prior to step c, the programmed processing system applying conversion factors to information transmitted by the entity to the programmed processing system for calculating various factors for use by the entity in evaluating each of the initiatives.

15. A programmed processing system for carrying out the following method:
a. receiving, by the programmed processing system, a transmission from an entity identifying a budget for achieving a reduction goal;
b. receiving, by the programmed processing system, a transmission from the entity used to identify a plurality of possible initiatives, customized for the entity, which, in certain combinations, may achieve the reduction goal within the budget, an initiative being an action or project that has a quantifiable cost and a quantifiable associated reduction per time period;
c. receiving, by the programmed processing system, a transmission from the entity identifying a subset of the possible initiatives for achieving the reduction goal;
d. processing, by the programmed processing system, information associated with the subset to determine at least a total cost of the subset and a total reduction if the subset was implemented;
e. transmitting, by the programmed processing system for review by the entity, the total cost of the subset and a total reduction if the subset was implemented;
f. receiving, by the programmed processing system, a transmission from the entity identifying whether the subset of the possible initiatives for achieving the reduction goal is approved by the entity;
g. if the entity has not approved the subset of the possible initiatives, then receiving, by the programmed processing system, one or more transmissions from the entity identifying other subsets of the possible initiatives for achieving the reduction goal; and
h. repeating steps d-g for the other subsets until the entity has approved a subset of the possible initiatives.

16. The processing system of claim 15 further programmed to carry out the method comprising:
processing, by the programmed processing system, the plurality of possible initiatives to rank the initiatives with respect to achieving the entity's objectives; and
prior to step c, transmitting for review by the entity a listing of the plurality of possible initiatives in a ranked order.

17. The processing system of claim 16 wherein the programmed processing system is further programmed to rank the initiatives based on how well each of the initiatives meets a variety of objectives of the entity, wherein at least some of the objectives have a weighting indicating an importance of the objective to the entity.

18. The processing system of claim 15 further programmed to carry out the method comprising, prior to step c, generating a spreadsheet for review by the entity, the spreadsheet identifying the plurality of possible initiatives in a ranked order based on how well each initiative met objectives of the entity.

19. The processing system of claim 15 wherein step c comprises the programmed processing system receiving the transmission from the entity selecting a subset of the possible initiatives from the spreadsheet.

20. A computer readable media including program instructions which when executed by a processing system cause the processing system to perform a method comprising:
a. receiving, by the processing system, a transmission from an entity identifying a budget for achieving a reduction goal;
b. receiving, by the processing system, a transmission from the entity used to identify a plurality of possible initiatives, customized for the entity, which, in certain combinations, may achieve the reduction goal within the budget, an initiative being an action or project that has a quantifiable cost and a quantifiable associated reduction per time period;
c. receiving, by the processing system, a transmission from the entity identifying a subset of the possible initiatives for achieving the reduction goal;
d. processing, by the processing system, information associated with the subset to determine at least a total cost of the subset and a total reduction if the subset was implemented;
e. transmitting, by the processing system for review by the entity, the total cost of the subset and a total reduction if the subset was implemented;
f. receiving, by the processing system, a transmission from the entity identifying whether the subset of the possible initiatives for achieving the reduction goal is approved by the entity;
g. if the entity has not approved the subset of the possible initiatives, then receiving, by the processing system, one or more transmissions from the entity identifying other subsets of the possible initiatives for achieving the reduction goal; and
h. repeating steps d-g for the other subsets until the entity has approved a subset of the possible initiatives.
